(19) United States
(12) Patent Application Publication
(10) Pub. No.: US 2008/0005366 A1
(43) Pub. Date: Jan. 3, 2008

(54) Apparatus and methods for handling requests over an interface

(76) Inventors: Sreenidhi Raatni, San Diego, CA (US); Tadeusz Jarosinski, San Diego, CA (US)

Correspondence Address: QUALCOMM INCORPORATED, 5775 MOREHOUSE DR., SAN DIEGO, CA, 92121, US

(21) Appl. No.: 11/398,157

(22) Filed: Apr. 4, 2006

(51) Int. Cl. G06F 3/00

(52) U.S. Cl. 710/8

(57) ABSTRACT

Apparatus and methods for an interface are disclosed. In particular, an apparatus for handling hardware requests over an interface between a hardware circuit and another circuit, such as a radio frequency integrated circuit (RFIC) is disclosed. The hardware request controller apparatus utilizes a configuration memory that receives and stores data concerning memory address locations within a data memory, also within the controller. The data memory receives and stores read or write data used for reading data from and writing data to the other circuit. The controller apparatus also includes master state machine logic that receives the hardware request commands from the hardware circuit and determines which address locations are to be accessed in the data memory based on the data concerning memory locations stored in the configuration memory. An interface dependent logic, adapted to the particular interface bus, is also provided to transfer read out data from the data memory to the other circuit via an interface bus. Corresponding methods are also disclosed.

### BACKGROUND

1. Field

The present application relates to apparatus and methods for an interface and, more particularly, apparatus and methods effecting an interface controlled through utilization of dedicated hardware that does not require software dynamic intervention for carrying out communication over the interface.

2. Background

In electrical devices, particular those utilizing microprocessors and integrated circuits, communications between circuits in such devices normally require some type of interfacing to effect those communications. Certain types of interfaces, such as those between a hardware circuit to another hardware circuit utilize the intervention of software instructions for addressing the communications and determining what type of communication signals are being communicated. As an example, in communication devices, such as mobile phone devices, it is known to communicate between a microprocessor (e.g., a General Purpose Processor (GPP) or digital signal processor (DSP)) or other hardware circuitry and one or more RF (Radio Frequency) chips, which are used for transmitting and receiving wireless signals, using an interface, such as a serial interface. Typically, the RF chips communicate with either the microprocessor or a dedicated hardware controller, both of which may issue requests (e.g., read and writes) via the interface. In this example, the interface may be a serial bus interface, which is known for providing control of RF chips, but other known types of serial or parallel interfaces may also be utilized. It is noted that the RF chips may consist of integrated circuits (RFIC), circuit blocks or circuit modules

Furthermore, given the examples above, specific types of control in a communication device are effected via the interface with the RF chips. In particular, various functional blocks within an RF chip require initialization and updates when certain events occur. One such event is when the communication device is powered on. Another event could be when the device switches between active states and sleep states (for conserving energy) while being powered on and off. Other control communications carried out via the interface could include updating DC correction values and changing gain states. Typically, the routing for these service requests, also termed “hardware requests” since they are typically originated by dedicated hardware, is performed by hard coding the service routines for each service (hardware) request. Such hard coding, however, can result in inflexible hardware prone to errors.

### SUMMARY

According to an aspect of the present disclosure, a hardware request controller for control of interfacing between a hardware circuit and another circuit is disclosed. The controller includes a first memory configured to receive and store data concerning memory address locations in another memory. A second memory is also included and configured to receive and store at least one of read data or write data used for reading data from and writing data to the another circuit. The controller further includes master state machine logic configured to receive at least one hardware request command from the hardware circuit and to determine address locations to be accessed in the second memory based on the data concerning memory locations stored in the first memory. Finally, the controller includes interface dependent logic configured to transfer read out data from the second memory to the another circuit via an interface bus.

According to another aspect of the present disclosure, an interface apparatus is disclosed having a microprocessor interface configured to interface the interface apparatus with a microprocessor. The apparatus also includes a hardware request controller configured as a hardware circuit and operable to receive hardware requests from hardware circuits and data from the microprocessor through the microprocessor interface. The interface apparatus further includes a bus interface module including a software port configured to receive data from the microprocessor interface, an arbiter configured to arbitrate between data output by the software port and the hardware request controller, and a bus interface configured to communicate data from at least one of the hardware request controller and the microprocessor to an external circuitry via an interface bus.

According to still another aspect of the present disclosure, a transceiver is disclosed including at least one radio frequency transmission circuit and a microprocessor interface configured to interface the interface apparatus with a microprocessor. The transceiver also includes a hardware request controller configured as a hardware circuit and operable to receive hardware requests from hardware circuits and data from the microprocessor through the microprocessor interface. Finally, the transceiver features a bus interface module including a software port configured to receive data from the microprocessor interface, an arbiter configured to arbitrate between data output by the software port and the hardware request controller, and a bus interface configured to communicate data from at least one of the hardware request controller and the microprocessor to the at least one radio frequency transmission circuit via an interface bus.

According to yet another aspect of the present disclosure a method for interfacing between a first hardware circuit and a second circuit is disclosed. The method includes receiving at least one hardware request from the first hardware circuit; reading address data from a first memory device based on a mapping of the at least one hardware request to a memory location in the first memory, wherein the address data includes memory location information of data stored in a second memory device; reading the data stored in the second memory device by using the address data read from the first memory to an interface module; and executing an operation in the interface module to interface with the second circuit based on the data read from the second memory device.

According to another aspect of the present disclosure, an apparatus for interfacing two circuits is disclosed. The apparatus includes means for receiving at least one hardware request from the first hardware circuit; means for reading address data from a first memory device based on a mapping of the at least one hardware request to a memory location in the first memory, wherein the address data includes memory location information of data stored in a second memory device; means for reading the data stored in the second memory device by using the address data read from the first memory to an interface module; and means for executing an operation in the interface module to interface with the second circuit based on the data read from the second memory device.

According to still another aspect of the present disclosure, a computer-readable medium encoded with a set of instructions is disclosed. The instructions include an instruction for receiving at least one hardware request from the first hardware circuit; an instruction for reading address data from a first memory device based on a mapping of the at least one hardware request to a memory location in the first memory, wherein the address data includes memory location information of data stored in a second memory device; an instruction for reading the data stored in the second memory device by using the address data read from the first memory to an interface module; and an instruction for executing an operation in the interface module to interface with the second circuit based on the data read from the second memory device.

### BRIEF DESCRIPTION OF THE DRAWINGS

FIG. 1 is a block diagram of an exemplary system including a serial interface system according to the present disclosure.

FIG. 2 is a block diagram illustrating an exemplary serial interface system according to the present disclosure that includes the microprocessor interface 108, hardware request controller 110 and the serial bus interface module 114 illustrated in FIG. 1.

FIG. 3 is a block diagram of an exemplary hardware request controller that may be utilized in the system of FIG. 2.

FIG. 4 is an exemplary illustration of configuration and data memories that may be utilized in the hardware request controller of FIG. 3.

FIG. 5 is a flow diagram of an exemplary method for effecting an interface according to the present disclosure.

FIG. 6 is a flow diagram of an exemplary method for control of data retrieval from the data memory as shown in FIGS. 3 and 4.

FIG. 7 is a block diagram of another exemplary serial interface system.

Like numerals refer to like parts throughout the several figures of the drawings.

### DETAILED DESCRIPTION

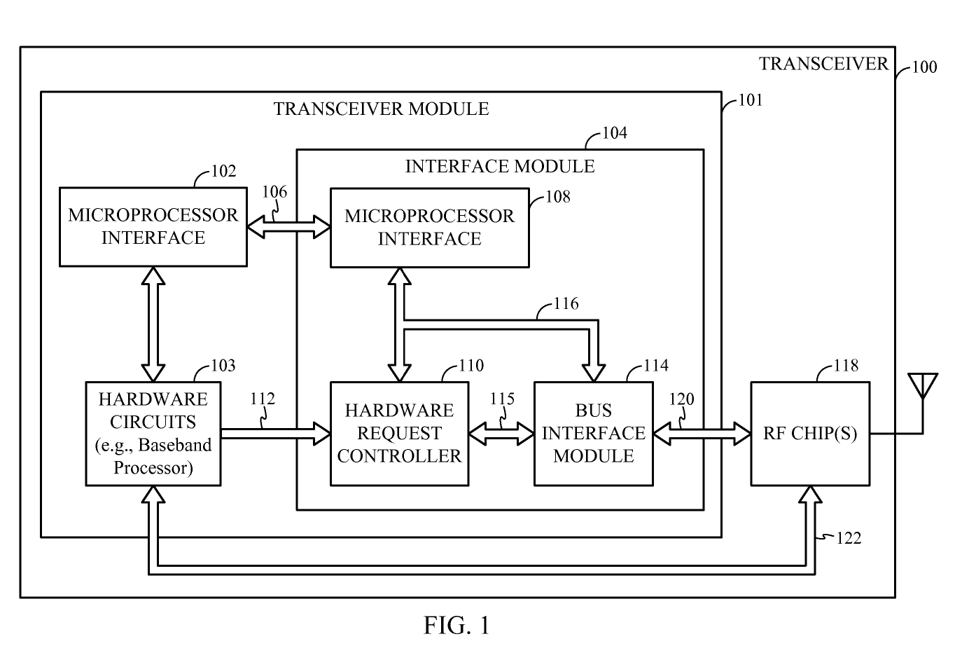

The present disclosure includes methods and apparatus for effecting an interface that is flexible by allowing software coding of hardware portions of the interface. In particular, FIG. 1 illustrates a block diagram of an exemplary communication device including a serial interface system according to the present disclosure. As illustrated, the device includes a transceiver 100 with a transceiver module 101 having a microprocessor 102, such as a general purpose processor (GPP) or similar processor. The transceiver module 101 also includes hardware circuits 103, which may consist of a baseband circuit, such as a baseband chip (i.e., an ASIC) for receiving and processing wireless communication signals (e.g., Orthogonal Frequency Division Multiplexed Access (OFDMA) signals or any other type of wireless transmissions) and a sleep mode controller for controlling sleep modes operation for the transceiver module 101.

The transceiver module 101 further includes an interface module 104 used as an interface for requests and instructions communicated between the microprocessor 102 and hardware circuits 103 with RF chips 118. The interface module 104 may be supported by and in communication with the microprocessor 102 via one or more interfaces 106, such as a General Purpose Input Output (GPIO), an external bus interface, SPI or I²C buses as examples.

Interface module 104 includes a microprocessor interface 108, which serves to transmit requests and information between the module 104 and the microprocessor 102. Interface module 104 also includes a hardware request controller 110, which receives hardware service requests 112 from the hardware circuits 103 within the transceiver module 104. Such hardware requests could include, but are not limited to, DC Offset correction, automatic gain control (AGC) and sleep control commands for energy saving sleep operation of the transceiver module 104. It is noted, however, that the disclosed implementation is not limiting, and the requests could be any type of requests, such as read/write requests that are communicated from one device to another via an interface, whether serial or parallel.

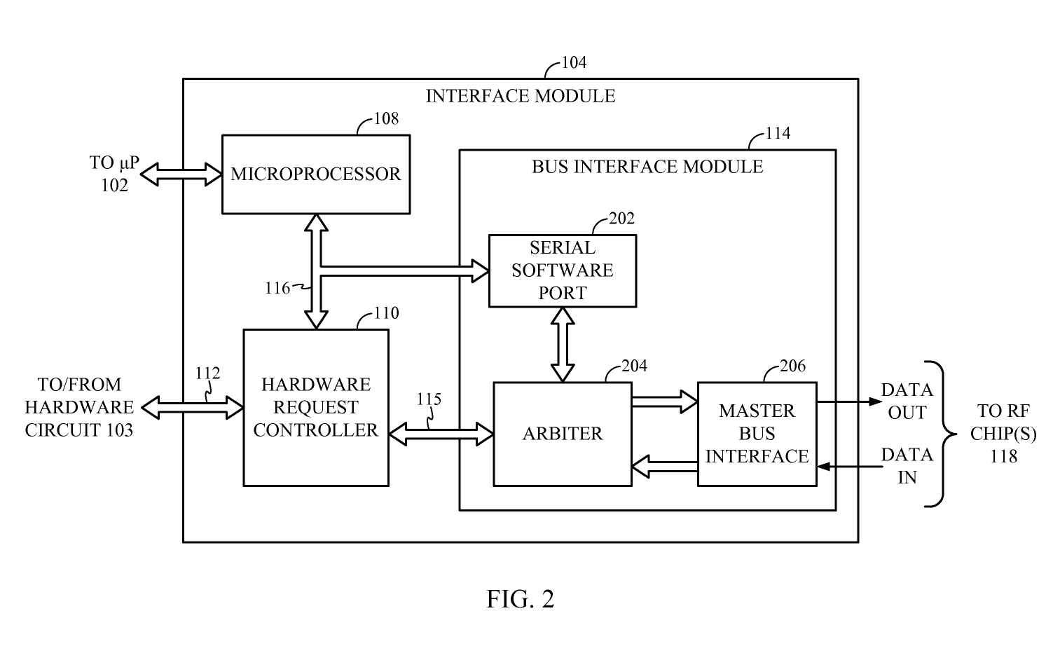

The hardware request controller 110 serves to receive hardware requests 112 and, in turn, effect the timing or ordering of the output of these requests to a bus interface module 114, as will be explained below in connection with FIGS. 2-4. Hardware request controller 110 may be implemented as an ASIC (Application Specific Integrated Circuit) or any other suitable hardware implementation.

The requests output by the hardware request controller 110 are sent to the bus interface module 114 via connection 115 in order to execute write and read operations with the RF chips 118 over the bus interface module 114 and bus 120 using various signals, which will be discussed later. It is noted here, however, that although the bus interface module 114 and bus 120 in the disclosed examples typically effect a serial bus interface, one of ordinary skill in the art will appreciate that the present disclosed interface may also be applicable to other types of interfaces as well, such as parallel interfaces.

Additionally, as illustrated with a microprocessor interface bus 116, the hardware request controller 110 may also receive configuration data from software run by microprocessor 102, via the microprocessor interface 108. The interface bus 116 is also configured to direct software requests directly to the bus interface module 114. The bus interface module 114 decides or “arbitrates” between hardware requests from the hardware request controller 110 via connection 115 and software requests received via interface 108 and interface bus 116. The requests and accompanying data are sent to RF chips 118 (e.g., data write requests). Additionally, data may be received from the RF chips 118 (e.g., data read requests).

The system of FIG. 1 ensures that all events requiring access to the RF chip(s) 118 are specifically treated as hardware requests that are serviced in a predetermined order. This approach provides flexibility where the service routines for hardware requests can be configured through software. Additionally, software requests may be interfaced to the hardware request controller 110 via the interface 108 and bus 116 such that the software requests appear as hardware requests to the hardware request controller 110.

Of further note, FIG. 1 also illustrates a bus connection 122, which is used to relay communication information (e.g., symbols, packets, frames, etc. for communication according to a standard, such as CDMA or OFDMA) between the baseband processor in the hardware circuit 103 and the RF chips 118. This information is distinct and independent of the control data, which is communicated between the microprocessor 102 or hardware circuits 103 and the RF chips 118 via the interface module 104.

FIG. 2 is a block diagram illustrating an exemplary interface system according to the present disclosure that may be used in the system of FIG. 1, and includes the interface module 104, microprocessor interface 108, hardware request controller 110 and the bus interface module 114 illustrated in FIG. 1. As shown, the bus interface module 114, in particular, includes a serial software port 202 in communication with the microprocessor interface 108 through interface bus 116. The serial software port 202 receives software requests for the RF chip(s) 118. Software port 202 is used to send software requests directly to an arbiter 204, which decides or arbitrates the ordering of requests between hardware and software requests received directly from the interface 108 and hardware requests from the hardware request controller 110 via connection 115. The resultant requests arbitrated by arbiter 204 are, in turn, sent to a master bus interface/serializer 206, which serializes, in the case of serial interface, the data and requests for transmission to the RF chips 118 or receives data from the RF chips 118. It is noted that the hardware request controller 110 accesses the arbiter 204 for each write and read operation to be performed via the bus interface module 114.

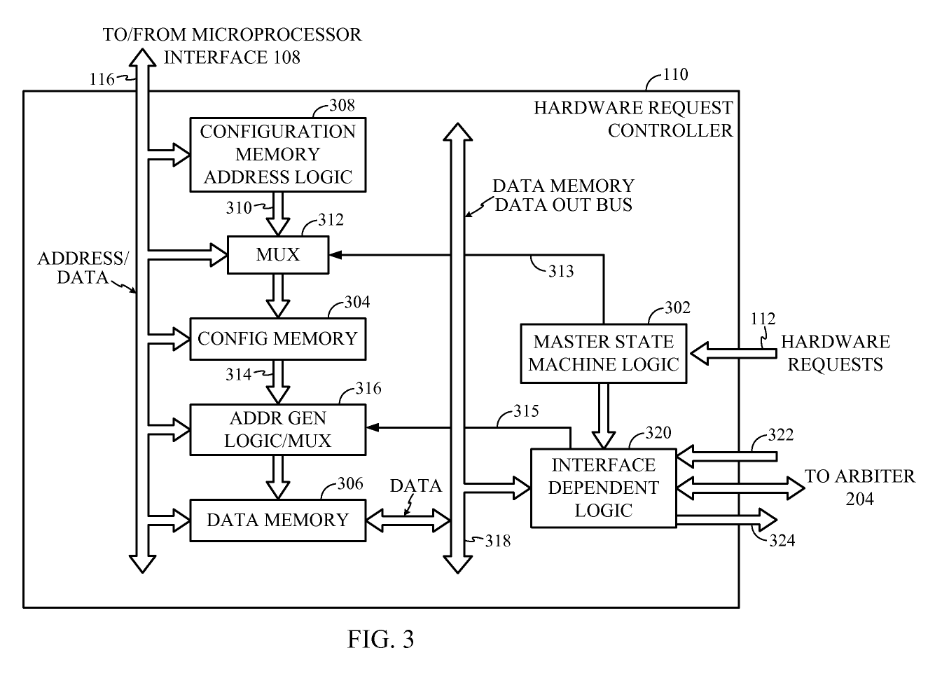

FIG. 3 illustrates a block diagram of an exemplary hardware request controller 110 as illustrated in FIGS. 1 and 2. As shown, the controller 110 includes a master state machine 302 that receives the hardware request 112. This state machine 302, which may be implemented in logic, serves to coordinate the activity of the hardware request controller 110 from when a request has been asserted to when it is finally serviced. In particular, the state machine 302 detects when a new request is received. The state machine 302 also determines if already pending requests have been serviced and waits to service the current request once the other pending requests are completed. Moreover, the state machine 302 may be further used to coordinate activities that are to be performed, and prioritizing particular requests from the hardware such as DC offset requests and automatic gain control (AGC) requests.

In servicing requests, the master state machine 302 directs the reading and writing of data within a configuration memory 304 and a data memory 306. The configuration and data memories 304, 306 store address and data information for write and read operation performed over the serial interface module 114. Additionally, the controller 110 includes configuration memory address logic 308 to point to dedicated address space within the configuration memory 304 for each hardware and software request received by the controller 110.

Concerning the configuration address logic 308, this logic 308 assigns each type of hardware request with its own individual corresponding address location in the configuration memory 304. In particular, logic 308 assigns starting addresses, which are actually corresponding addresses within the configuration memory 304. Thus, each type of hardware request is mapped to a corresponding starting address within the configuration memory 304 by logic 308, which in turn contains address information and the numbers of locations for data within the data memory 306. When a particular hardware request is received, the configuration address logic 308 provides the address location to point to within the configuration memory 304. As an example of one configuration, which is illustrated in FIG. 3, in order to effect fetching of the address, the state machine 302 may direct selection of a read address 310 from logic 308 or data from the microprocessor interface 108 and 116 with a multiplexer 312 or similar device that allows an address in the configuration address logic 308 to be selectively passed to the configuration memory 304 under the control of a control signal 313. This, in part, is used to set the address pointer of the configuration memory 304 to the address (e.g. 310) delivered via the multiplexer 312.

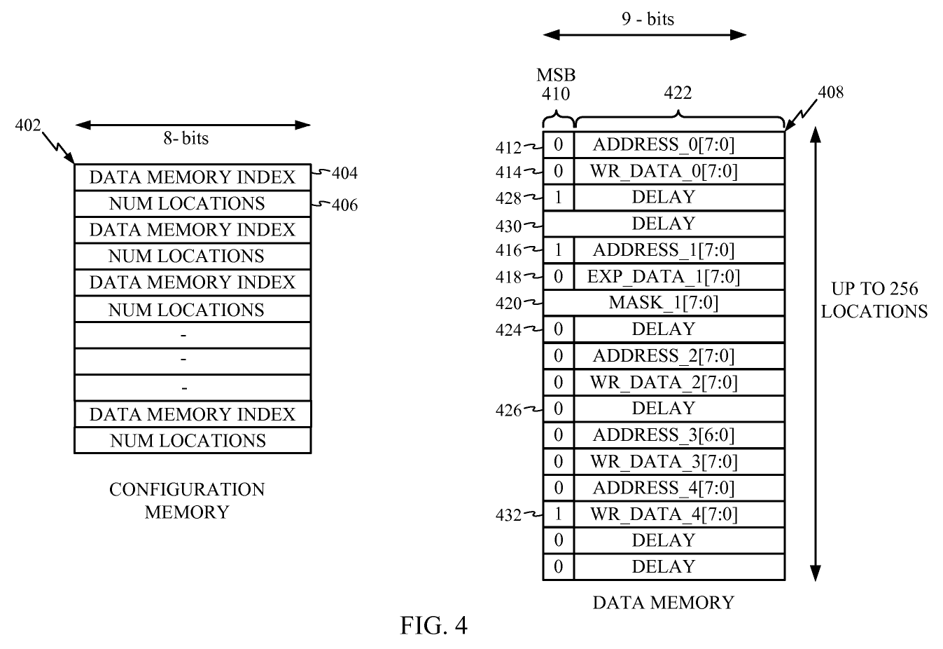

Once the pointer of configuration memory 304 is updated after a request is received, a corresponding data memory address 314 is read from the memory location in the configuration memory 304. As an illustration, FIG. 4 shows an exemplary representation 402 of configuration memory 304 having a number of memory locations. For the sake of example, it is assumed that the address derived from the configuration memory address logic 308 is the first address location 404 of the representative configuration memory 402. A data memory index is stored in location 404, which, in turn, refers to an address location within the data memory 306. That is, the data memory index stored in location 404 is the memory location for the first address location or starting address in the data memory 306. After the address at location 404 is read, the configuration memory pointer is then incremented to a next location (e.g., 406) that stores an actual number of read operations, which is indicated by “NUM LOCATIONS,” to be performed from the data memory 306. It is noted that if this number is zero, the hardware request controller 110 assumes that no operation will be performed and the request is ignored.

It is noted that the width of the configuration memory 304 (or 402 in FIG. 4) is set to a value of n bits where 2ⁿ is less than or equal to the number of locations in the data memory 306. In the example of FIG. 4, the width is set to 8-bits wide assuming a maximum size of the data memory 306 is 256 locations. It is noted that these sizes are only for purpose of example and could be lesser or greater.

The operation described above is effected under direction of an interface dependent logic 320 that issues a memory index signal 315 to allow memory addresses 314 to be read out of the configuration memory 304 by an address generation logic/multiplexer 316 causing the particular data memory address to be selected for the pointer location of the data memory 306.

As illustrated further in FIG. 4, an exemplary representation 408 of the data memory 306 is shown. In this particular example, the data memory 408 is 9-bits wide, but could be any width desired. Once the address of the first location and the number of locations to be read is determined, the data memory 408 is read with the read pointer incrementing with every read. The most significant bit (MSB) 410 field of an address field (e.g., the address field stored in location 412) specifies whether a read or a write operation will be performed through the bus interface module 114. As an example, this MSB field 410 may be set to a binary value of one (1) for read operations and cleared to a binary zero (0) for write operations.

A memory location 414 following the address field 412 contains data to be written for write operations (e.g., WR_DATA). In the case of a read, on the other hand, the data field, such as shown at located 418, after an address field (e.g., location 416) represents the expected data that will be read (e.g., EXP_DATA). Additionally, a location 420 following expected read data is used to mask specific bits during comparison. The bit positions indicated by a 1 in the mask are then excluded (or, alternatively, included, whereas positions indicated by a zero are excluded) from comparison. If the most significant bit (410) of the data field is set to a value of one (1), for example, the read or write command stored therein will be ignored and no operation (NOP) will be performed. An example of a NOP is illustrated by location 432, including a write operation. The MSB field 410 of location 432 is set to a value of one (1) and, thus, will ensure no operation is performed.

According to another featured aspect, a transaction can also be delayed by a time amount specified by either one or two locations preceding the address location. As an example, the delay values listed can be in multiples of clock cycles of the clock supplied to the hardware request controller 110. More particularly, in a wireless transceiver that utilizes a Temperature Compensated Crystal Oscillator (TCXO) for system timing, the delay could be set to multiples of 20 TCXO clock cycles, for example. Accordingly, a value of 25 decimal would yield a delay of the next transaction by 25*20 (=500) TXCO clock cycles. If the delay value is small enough to fit within one row, the most significant bit of the first delay location can be cleared (i.e., set to a binary value of 0). The rest of the bits (i.e., the eight bit field 422 of the location) then represent the time by which the next transaction will be delayed. In such cases, the next row within the data memory 408 will hold the address of the next transaction. Examples of these delay entries are shown with reference numbers 424 and 426 in FIG. 4.

On the other hand, if a delay value is too great to be stored within a single row of the data memory 408, the most significant bit of the first delay location can be set to a binary value of one (1) and the location immediately following that location can be further used to represent the delay. In such a case, the eight bits (field 422 excluding the most significant bit field 410) are read from the first location and this first eight bits forms the LSB and the least significant eight bits (plus one bit, which is MSB field 410) from the second location forms the MSB of the delay value. An illustration of such a delay entry may be seen in FIG. 4 denoted by reference numerals 428 for the first location and 430 for the immediately following second location.

If a transaction has to be delayed by a value greater than what can be specified in two locations in the data memory 408, adjacent instructions can be marked as No Operation (NOP) by setting the MSB of the data field (410) to a binary value of one (1). The delay fields corresponding to these NOP instructions will still be valid and can be combined to create even larger delays between transactions if needed.

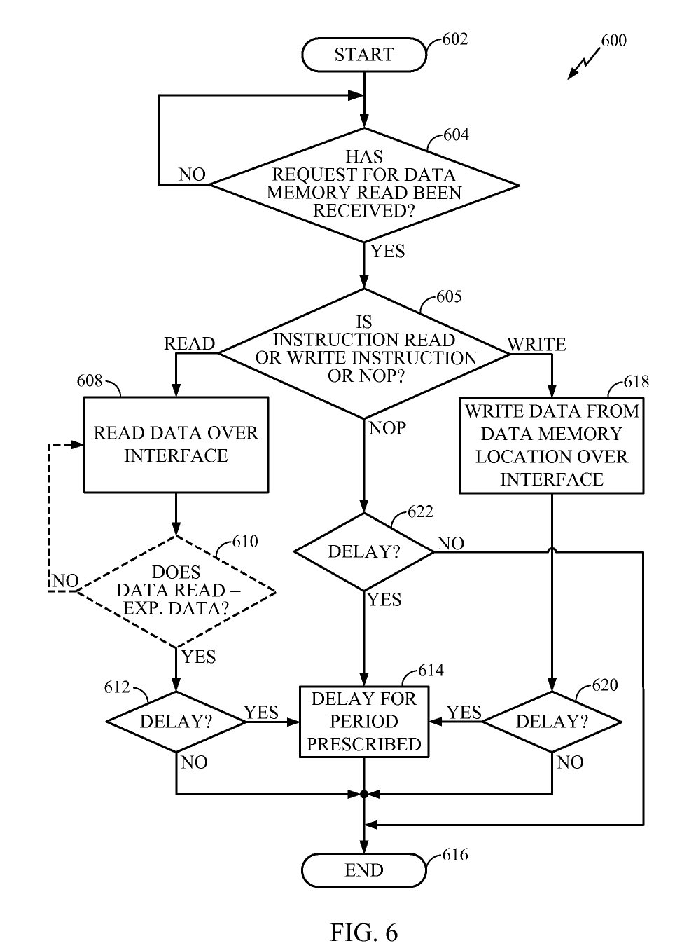

Turning again to FIG. 3, the hardware request controller 110 also includes an interface dependent logic 320, which serves to request use of the serial interface module 112 by first asserting a request signal 322 for each transaction in the data memory 306 to the arbiter 204. The request signal address, data (in case of a write), and the read/write signal is maintained until the arbiter has responded to the logic 320 with an acknowledgement signal 324. The logic 320 then waits for the assertion of the done signal by the arbiter 204 before prompting a data memory logic, which is discussed below in connection with FIG. 6, to read from the data memory 306. Logic 320 also may be configured to drain the data memory 306. Further, the data memory read operation and the logic 320 may be controlled together by a data memory control state machine, which will be discussed in further detail later.

It is further noted that the master state machine logic 302 or data memory control logic within the hardware request controller 110 may include a counter or counters (not shown) in order to keep track of how many locations are read from the data memory 306. The counter or counters could also be used to keep track of how many times data from registers in the RF chips 118 have been read out prior to matching the expected value.

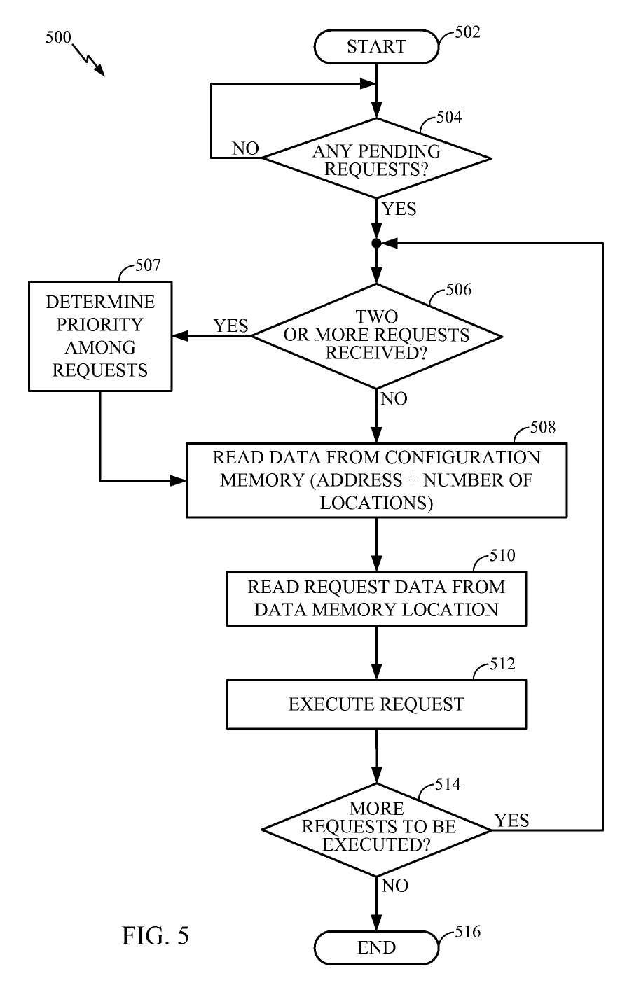

FIG. 5 illustrates a flow diagram of an exemplary method for effecting an interface according to the present disclosure. The process 500 of FIG. 5 is performed primarily by the master state machine 302 within the controller 110, but is not limited as such. As shown, the process 500 begins at start block 502 when a hardware request 112 has been received and proceeds to decision block 504. At block 504, the state machine 302 determines whether a pending hardware request is asserted. If not, the process continues to loop back until any pending hardware request has been received and flow proceeds to decision block 506.

At block 506, the state machine next determines whether multiple requests have been received. If two or more requests are pending, flow proceeds to block 507 where priority between the requests is determined and then flow proceeds to block 508. This priority may be determined by the state machine 302. Alternatively, if only one request is received as determined at block 506, flow simply proceeds directly to block 508

At block 508 the state machine 302 directs a read operation of the address and number of location (NUM LOCATIONS) from the configuration memory 304. As an example of an implementation of this functionality, the master state machine 302 causes the memory index signal 314 to be delivered by the address generation logic/multiplexer logic 316 through signal 313 to effect reading of the data in configuration memory 304 to data memory 306. It is noted that the process 500 will remain at block 508 until all of the configuration memory locations are read and the pointers and counters are updated.

After the configuration memory locations are read, flow proceeds to block 510, where the data in the data memory 306 is read out iteratively. Further details of the operation of block 510 are discussed below in connection with FIG. 6.

It is noted that for the particular implementation of FIGS. 2-4, the data memory 306 contains logic or a state machine (not shown) that governs how the data in the specified locations of the data memory 306 are read out. Once the operation of block 510 is completed, flow proceeds to block 512 where the particular request connected with the data read out of memory 306 is executed via the bus interface module 114. Once the request is executed, the process 500 proceeds to decision block 514 for a determination of whether more requests need to be executed, such as when multiple requests have been received as was determined in block 506. If more requests are to be serviced, flow proceeds back to block 506. Otherwise, flow proceeds to block 516 where process 500 terminates.

FIG. 6 illustrates a process 600 for reading out the data in data memory 306 according to the present disclosure. It is noted that this process may be performed by logic within the data memory 306 or with logic external to the memory 306. As shown in FIG. 6, process 600 begins at start block 602 and proceeds to decision block 604. At block 604, the process determines whether a request for the data memory to be read has been received (e.g., address locations and number of locations provided from configuration memory 304 via the address generation logic 316). If a request is not received, the process loops back until a request is received.

Once a request is received, the process 600 proceeds to decision block 606, which differentiates between whether the request will require a read or write of data to or from the RF chips 118, as an example, or is a No Operation (NOP) entry, like that illustrated by data memory location 432, discussed previously. If the instruction is a read instruction, flow proceeds to block 608; where the instruction is read out from the data memory to direct the interface module 114 to read data from the RF chips 118. If the instruction requires a checking or comparison of the data read from the RF chips 118 to an expected value, as discussed previously in connection with entries 420 and 418 in FIG. 4, an additional procedure may be included in process 600. Specifically, as shown with dashed lines, a decision block 610 may be included to determine whether the data read from the RF chips 118 matches expected data. An exemplary application of this process is a determination of when a Phase Lock Loop (PLL) has locked in the RF chips 118. In such an instance, the binary data read from chips 118 are masked and then compared to expected data known for a PLL lock. Thus, in the case of block 610, the process 600 will continue to loop back to block 608 until the read and masked data matches the expected data. After either block 608 is performed or the condition of alternate block 610 is met, flow then proceeds to decision block 612.

Decision block 612 determines whether a delay is desired. If a delay is desired, flow proceeds to block 614, where the delay operation is effected for a prescribed time period. For example, if the data read from data memory 306 includes two delays, such as delays illustrated by locations 428 and 430 in FIG. 4, no data memory operations are performed until the delay is complete. Flow then proceeds to block 616 for termination of the process 600. Alternatively, if no delay is desired, as determined at block 612, flow simply proceeds directly to block 616.

If the instructions read from the data memory 306 indicate a write instruction as determined at decision block 606 , flow will proceed to block 618. At block 618, data to be written to the RF chips 118 stored in the data memory (e.g., location 414 shown in FIG. 4) will be read out over the interface (e.g., interface module 114). When the procedure of block 618 is complete, flow proceeds to decision block 620 to determine if a delay is desired. If so, flow proceeds to block 614 for delay of a prescribed period and then flow proceeds to termination block 616. Alternatively at block 620, if no delay is desired, flow simply proceeds to block 616.

Finally, if the data read from the data memory indicates a NOP (i.e., the MSB of the next location in data memory 306 is equal to a “1”) as determined at block 606, flow simply proceeds to decision block 622 to determine if a delay is desired. If so, flow proceeds to block 614 for delay of a prescribed period as determined by the data read out from data memory 306 and then flow proceeds to termination block 616. Alternatively at block 620, if no delay is desired, flow simply proceeds directly to block 616.

It is noted that the process 600 correlates to the process of block 510 in FIG. 5 and is executed with logic in the data memory 306. Alternatively, however, logic resident elsewhere in the hardware request controller 110 or even outside of the controller 110 may effect the process. It is also noted that the determinations concerning whether a delay is desired as indicated by decision blocks 612, 620, and 622 in FIG. 6 may alternatively be omitted from process 600. Instead, the data memory 306, 408 can be configured such that a delay is always present between two operations, thus eviscerating the need for these delay determinations.

Concerning the effecting of read commands in the particular disclosed in the example of FIG. 6 above, it is noted that a read command may be interpreted dependent on the delay values immediately preceding the address field. For instance, if the delay is cleared, the control logic may remain in a loop and continue reading the same location in RF chip 118 until the read data matches the expected value, as mentioned above with respect to alternate block 610. The number of clock cycles elapsed while staying in the loop waiting for the expected data may be stored in a register, which can be read periodically by software, such as software running on microprocessor 102, to adjust future delay values written to the data memory 306 if needed. In a further example, if the delay preceding the address was not cleared, the control logic in the interface module 114 may then effecting waiting until the delay time is elapsed and then proceed to read the register location in the RF chips 118. The received data is compared with the expected value and a status bit is set if there was no match.

According to another example, hardware request controller 110, in conjunction with the interface module 114, may be used to turn on the RF chips 118, such as at start up of the transceiver or when the transceiver enters or is brought out of an energy-saving sleep mode. In the situations of bringing the transceiver into or out of a sleep mode, in particular, the RF chip turn on (or off) may be accomplished by writing predetermined data from the software via interface 116 to specific locations in the data memory 306 during start-up.

Turning back to FIG. 1, it is also noted that in another example, software running on the microprocessor 102, for example, can directly access registers in RF chips 118 via the interface 116 and the bus interface module 114. Additionally, the hardware request controller 110 may receive software instructions from the microprocessor 102 via the interface 108 that may then be executed by the controller 110 in the same way that the hardware requests 112 are executed. As an example, software generated data may be stored in the configuration and data memories 304, 306 via interface bus 116 such that they are processed just as the hardware requests 112 are processed, even though they originate as software requests. Thus in this way, the hardware request controller 110 can serve to convert software instructions to hardware requests.

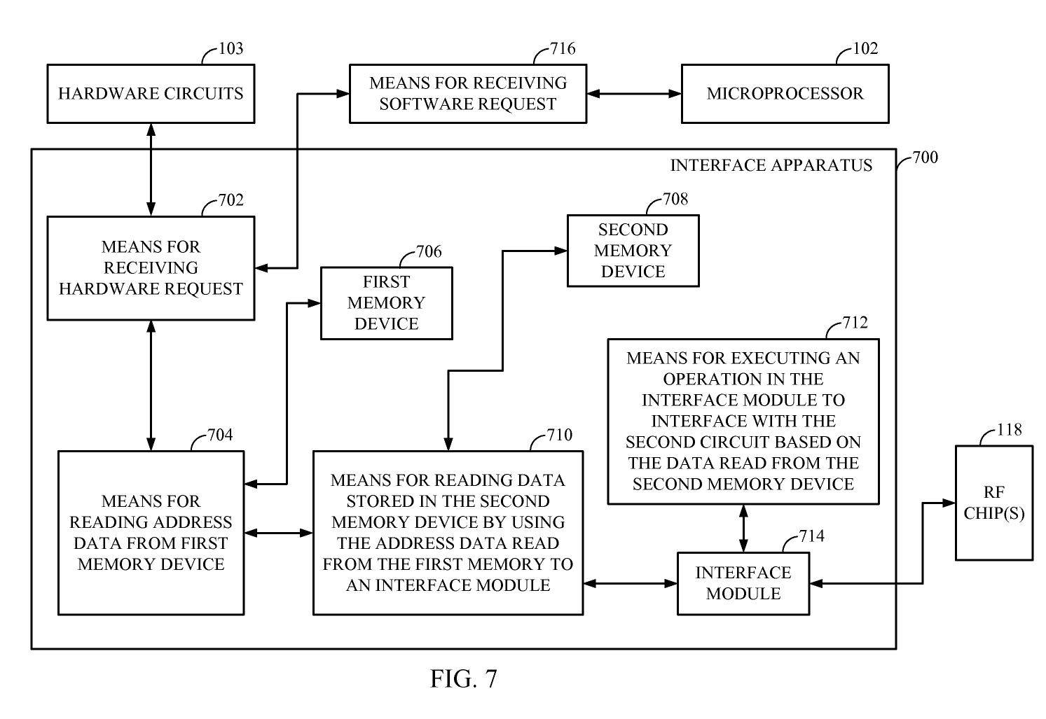

FIG. 7 illustrates another example of an interface apparatus 700 for effecting an interface between hardware circuits and RF chips. In this example, the apparatus 700 includes means for receiving hardware requests 702, which receives the requests from hardware circuits 103, as an example. Means 702 is in communication with means for reading address data from a first memory device 704, and is configured to read the address data in a first memory device 706 based on a mapping of the at least one hardware request to a memory location in the first memory. The address data includes memory location information of data stored in a second memory device 708, such as the data memory index and number of locations as discussed previously in connection with FIGS. 3 and 4.

The apparatus 700 further includes means for reading the data stored in the second memory device 710 by using the address data read from the first memory device 706 and reading the data to an interface module to an interface module 714. The interface module is also in communication with means for executing an operation in the interface module 712, in order to effect interfacing with the second circuit based on the data read from the second memory device 708.

It is noted that the first and second memory devices 706, 708 correspond to the configuration memory 304 and the data memory 306, discussed previously. Additionally, means 702, 704 and 710 may implemented by the master state machine 302 and the state machine in the data memory 306, discussed above. Means 712 may be implemented by the state machine 302, the data memory state machine, the interface dependent logic 320, and the arbiter 204 discussed above. Finally, the interface module 714 may be implemented by the interface module 114 discussed previously.

The disclosed apparatus and methods afford an interface utilizing hardware that is more flexibly configured with a reconfigurable configuration and data memories. This allows the hardware to have more flexibility like software to reduce errors typical with hardcoding in previous interfaces without the attendant latency inherent with serving these requests in software compliant with different interfaces. Accordingly, the present interface ensures that requests from hardware circuits are communicated in a timely fashion to avoid errors resulting from missed timing due to delay of either hardware or software.

The examples described above are merely exemplary and those skilled in the art may now make numerous uses of, and departures from, the above-described examples without departing from the inventive concepts disclosed herein. Various modifications to these examples may be readily apparent to those skilled in the art, and the generic principles defined herein may be applied to other examples, e.g., in an instant messaging service or any general wireless data communication applications, without departing from the spirit or scope of the novel aspects described herein. Thus, the scope of the disclosure is not intended to be limited to the examples shown herein but is to be accorded the widest scope consistent with the principles and novel features disclosed herein. The word “exemplary” is used exclusively herein to mean “serving as an example, instance, or illustration.” Any example described herein as “exemplary” is not necessarily to be construed as preferred or advantageous over other examples. Accordingly, the novel aspects described herein is to be defined solely by the scope of the following claims.

What is claimed is:

1. A hardware request controller for control of interfacing between a hardware circuit and another circuit, the controller comprising:
a first memory configured to receive and store data concerning memory address locations in another memory;
a second memory configured to receive and store at least one of read data or write data used for reading data from and writing data to the another circuit;
master state machine logic configured to receive at least one hardware request command from the hardware circuit, and to determine address locations to be accessed in the second memory based on the data concerning memory locations stored in the first memory; and
interface dependent logic configured to transfer read out data from the second memory to the another circuit via an interface bus.

2. The hardware request controller as defined in claim 1 wherein at least one of the first and second memories are reconfigurable by being configured to receive software generated data and address information from a microprocessor running the software that overwrites previous information stored in at least on of the first and second memories.

3. The hardware request controller as defined in claim 1 further comprising:
address logic configured to map a particular hardware request to a corresponding base address in the first memory.

4. The hardware request controller as defined in claim 3, wherein the at least one address register reconfigurable by being configured to receive software generated data and address information from a microprocessor running the software that overwrites previous information stored in at least on of the first and second memories.

5. The hardware request controller as defined in claim 1 further comprising:
second memory state machine logic configured to control reading out of data from the second memory under direction from the master state machine logic.

6. The hardware request controller as defined in claim 1, wherein the controller is configured as an application specific integrated circuit.

7. The hardware request controller as defined in claim 1, wherein the another circuit is at least one radio frequency chip.

8. The hardware request controller as defined in claim 1, wherein the master state machine logic is configured to control timing of reading out data concerning the at least one hardware request based on a predetermined timing data stored in the second memory.

9. An interface apparatus comprising:
a microprocessor interface configured to interface the interface apparatus with a microprocessor;
a hardware request controller configured as a hardware circuit and operable to receive hardware requests from hardware circuits and data from the microprocessor through the microprocessor interface; and
a bus interface module including a software port configured to receive data from the microprocessor interface, an arbiter configured to arbitrate between data output by the software port and the hardware request controller, and a bus interface configured to communicate data from at least one of the hardware request controller and the microprocessor to an external circuitry via an interface bus.

10. The interface as defined in claim 8, wherein the hardware request controller further comprises:
a configuration memory configured to receive and store data concerning memory address locations in another memory;
a data memory configured to receive and store at least one of read data or write data used for reading data from and writing data to the another circuit;
master state machine logic configured to receive at least one hardware request command from the hardware circuit, to determine address locations to be accessed in the second memory based on the data concerning memory locations stored in the first memory; and
interface dependent logic configured to transfer read out data from the second memory to the external circuitry via the bus interface module.

11. The interface apparatus as defined in claim 10, wherein at least one of the configuration and data memories is reconfigurable by being configured to receive software generated data and address information from a microprocessor running the software that overwrites previous information stored in at least on of the configuration and data memories.

12. The interface apparatus as defined in claim 10, wherein the hardware request controller further comprises:
at least one address register configured to map a particular hardware request to a corresponding base address in the first memory.

13. The interface apparatus as defined in claim 12, wherein the at least one address register is reconfigurable by being configured to receive software generated data and address information from a microprocessor running the software that overwrites previous information stored in at least on of the first and second memories.

14. The interface apparatus as defined in claim 10, wherein the hardware request controller further comprises:
second memory state machine logic configured to control reading out of data from the second memory under direction from the master state machine logic.

15. The interface apparatus as defined in claim 9, wherein the controller is configured as an application specific integrated circuit.

16. The interface apparatus as defined in claim 9, wherein the external circuit is at least one radio frequency chip.

17. The interface apparatus as defined in claim 10, wherein the master state machine logic is configured to control timing of reading out data concerning the at least one hardware request based on a predetermined timing data stored in the second memory.

18. A transceiver comprising:
at least one radio frequency transmission circuit;
a microprocessor interface configured to interface the interface apparatus with a microprocessor;
a hardware request controller configured as a hardware circuit and operable to receive hardware requests from hardware circuits and data from the microprocessor through the microprocessor interface; and
a bus interface module including a software port configured to receive data from the microprocessor interface, an arbiter configured to arbitrate between data output by the software port and the hardware request controller, and a bus interface configured to communicate data from at least one of the hardware request controller and the microprocessor to the at least one radio frequency transmission circuit via an interface bus.

19. The transceiver as defined in claim 18, wherein the hardware request controller further comprises:
a configuration memory configured to receive and store data concerning memory address locations in another memory;
a data memory configured to receive and store at least one of read data or write data used for reading data from and writing data to the another circuit;
master state machine logic configured to receive at least one hardware request command from the hardware circuit, to determine address locations to be accessed in the second memory based on the data concerning memory locations stored in the first memory; and
interface dependent logic configured to transfer read out data from the second memory to the at least one radio frequency transmission circuit via the bus interface module.

20. The transceiver as defined in claim 19, wherein at least one of the configuration and data memories is reconfigurable by being configured to receive software generated data and address information from a microprocessor running the software that overwrites previous information stored in at least on of the configuration and data memories.

21. The transceiver as defined in claim 19, wherein the hardware request controller further comprises:
at least one address register configured to map a particular hardware request to a corresponding base address in the first memory.

22. The transceiver as defined in claim 21, wherein the at least one address register reconfigurable by being configured to receive software generated data and address information from a microprocessor running the software that overwrites previous information stored in at least on of the first and second memories.

23. The transceiver as defined in claim 19, wherein the hardware request controller further comprises:
second memory state machine logic configured to control reading out of data from the second memory under direction from the master state machine logic.

24. The transceiver as defined in claim 19, wherein the hardware request controller is configured as an application specific integrated circuit.

25. The transceiver as defined in claim 19, wherein the master state machine logic is configured to control timing of reading out data concerning the at least one hardware request based on a predetermined timing data stored in the second memory.

26. A method for interfacing between a first hardware circuit and a second circuit, the method comprising:
receiving at least one hardware request from the first hardware circuit;
reading address data from a first memory device based on a mapping of the at least one hardware request to a memory location in the first memory, wherein the address data includes memory location information of data stored in a second memory device;
reading the data stored in the second memory device by using the address data read from the first memory to an interface module; and
executing an operation in the interface module to interface with the second circuit based on the data read from the second memory device.

27. The method as defined in claim 26, further comprising:
storing the address data in the first memory and the data in the second memory with software operating on a microprocessor.

28. The method as defined in claim 26, further comprising:
storing base address information in at least one configuration address logic wherein the base address information effects the mapping of the at least one hardware request to a memory location in the first memory,

29. The method as defined in claim 28, further comprising:
storing the base address data in the at least one base register with software operating on a microprocessor.

30. The method as defined in claim 26, further comprising:
delaying an operation to be performed in the interface module based on delay data stored in the second memory device.

31. The method as defined in claim 26, further comprising:
delaying execution of further operations during a read operation performed by the interface module until data read from the second circuit matches expected read data stored in the second memory device.

32. An apparatus for interfacing two circuits comprising:
means for receiving at least one hardware request from the first hardware circuit;
means for reading address data from a first memory device based on a mapping of the at least one hardware request to a memory location in the first memory, wherein the address data includes memory location information of data stored in a second memory device;
means for reading the data stored in the second memory device by using the address data read from the first memory to an interface module; and
means for executing an operation in the interface module to interface with the second circuit based on the data read from the second memory device.

33. The apparatus as defined in claim 32, further comprising:
means for storing the address data in the first memory and the data in the second memory from software operating on a microprocessor.

34. The apparatus as defined in claim 32, further comprising:
means for storing base address information in at least one configuration address logic wherein the base address information effects the mapping of the at least one hardware request to a memory location in the first memory,

35. The apparatus as defined in claim 32, further comprising:
means for storing the base address data in the at least one base register with software operating on a microprocessor.

36. The apparatus as defined in claim 32, further comprising:
means for delaying an operation to be performed in the interface module based on delay data stored in the second memory device.

37. The apparatus as defined in claim 32, further comprising:
means for delaying execution of further operations during a read operation performed by the interface module until data read from the second circuit matches expected read data stored in the second memory device.

38. A computer-readable medium encoded with a set of instructions, the instructions comprising:
an instruction for receiving at least one hardware request from the first hardware circuit;
an instruction for reading address data from a first memory device based on a mapping of the at least one hardware request to a memory location in the first memory, wherein the address data includes memory location information of data stored in a second memory device;
an instruction for reading the data stored in the second memory device by using the address data read from the first memory to an interface module; and
an instruction for executing an operation in the interface module to interface with the second circuit based on the data read from the second memory device.
